(19) United States
(12) Patent Application Publication
(10) Pub. No.: US 2014/0164323 A1
(43) Pub. Date: Jun. 12, 2014

(54) Synchronous/Asynchronous Storage System

(71) Applicant: TRANSPARENT IO, INC., Woodinville, WA (US)

(72) Inventors: Charles Edward Park, Redmond, WA (US); John Aaron Strange, Ft. Collins, CO (US); Robert Pike, Woodinville, WA (US)

(73) Assignee: TRANSPARENT IO, INC., Woodinville, WA (US)

(21) Appl. No.: 13/709,059

(22) Filed: Dec. 10, 2012

(51) Int. Cl. G06F 17/30

(52) U.S. Cl. CPC G06F 17/30174
USPC 707/611

(57) ABSTRACT

A storage system with a duplicate network storage device may change to and from a synchronous to asynchronous write connection based on a service level agreement. Degradation of a network connection or device performance may cause synchronous writes to be changed to asynchronous network writes, and synchronous writes may be performed on a second device. During the asynchronous operation, a differencing set may be created on a local storage device and used to update the network storage device. When the network storage device becomes able to meet the service level agreement with synchronous writes, the system may include the network storage device for synchronous writes.

### BACKGROUND

Storage systems that store multiple copies of data typically operate in one of two modes for write operations: synchronous or asynchronous. In a synchronous mode, a write operation is not complete until all of the devices have successfully completed the write. In an asynchronous mode, a write operation may be considered complete when one of the devices has successfully completed but when other devices may still be processing.

Synchronous write operations have an advantage that a completed write operation leaves the storage system in a consistent state where all the storage devices contain the same information. Asynchronous write operations can leave the storage system in an inconsistent state after one device has completed the write operation and before the remaining devices have been synchronized. If the system were to fail during the period of the inconsistent state, the data may not be easily recovered.

Asynchronous write operations have an advantage that a write operation may be considered complete when at least one device has successfully completed the operation. Devices that are slow do not cause a system slowdown as would be the case in synchronous writes.

### SUMMARY

A storage system with a duplicate remote or network storage device may change to and from a synchronous to asynchronous write connection based on a service level agreement. Degradation of a network connection or device performance may cause synchronous writes to be changed to asynchronous remote writes, and synchronous writes may be performed on a second device. During the asynchronous operation, a differencing file may be created on a separate storage device and used to update the remote storage device. When the remote storage device becomes able to meet the service level agreement with synchronous writes, the system may include the remote storage device for replicated synchronous writes.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

In the drawings,

FIG. 1 is a diagram illustration of an embodiment showing a computer system with a storage management system.

FIG. 2 is a diagram illustration of an embodiment showing a device with storage having different block extents.

FIG. 3 is a flowchart illustration of an embodiment showing a method for provisioning storage devices for a logical unit.

FIG. 4 is a flowchart illustration of an embodiment showing a method for configuring a logical unit for an image.

FIG. 5 is a flowchart illustration of an embodiment showing a method for processing a read request.

FIG. 6 is a diagram illustration of an embodiment showing an adaptive storage system.

FIG. 7 is a flowchart illustration of an embodiment showing a method for managing devices in a logical unit.

### DETAILED DESCRIPTION

A storage management system may store blocks of data on multiple storage devices, including remote or network connected storage devices. In a normal operation, the remote storage device may be configured for write operations that are performed synchronously with local or other storage devices to support data resilience agreements. Such a configuration may be operated within a service level agreement set by the workload, which may be related to input output performance parameters. When the network storage device becomes unavailable or when its performance decreases such that the service level agreement is not being met, the system may begin asynchronous write operations with the remote device. When the network device regains its performance, the system may revert to synchronous write operations.

When the system operates in an asynchronous mode, a differencing file, log file, or other mechanism may be created on a local device so that updates to the network storage device may be performed when possible. In some cases, another storage device may be used for synchronous write operation during the period that the network storage device may not be available.

The network storage device may be monitored to determine if the network storage device may meet the service level agreement. When the network storage device regains its performance such that the service level agreement may be met using synchronous writes, the network storage device may be brought up to date using a differencing file or other mechanism, then the system may switch over to synchronous write operations using the network storage device.

When the system operates the network storage device in an asynchronous mode, a differencing file may capture changes to the remote device. The changes may be propagated to the remote device when the remote device comes online or in an asynchronous manner when the device may be responding slowly.

In many cases, at least one of the storage devices in a storage system may be a network connected or remote storage device. The remote storage device may provide redundancy in the case of a failure of a local device or system, as well as may provide a destination for transferring a virtual machine or other operations.

A storage management system may present a single logical unit while providing the logical unit on a plurality of devices. The storage management system may maintain a service level agreement by configuring the devices in different manners and placing blocks of data on different devices.

The storage management system may manage storage devices that may include direct attached storage devices, such as hard disk drives connected through various interfaces, solid state disk drives, volatile memory storage, and other media including optical storage and other magnetic storage media. The storage devices may also include storage available over a network, including network attached storage, storage area networks, and other storage devices accessed over a network.

Each storage device may be characterized using parameters similar to or derivable from a service level agreement. The device characterizations may be used to select and deploy devices to create logical units, as well as to modify the devices supporting an existing logical unit after deployment.

The service level agreement may define certain parameters that may be applied to storage blocks having the same characteristics. Such a system may allow certain types of blocks to have different service level parameters than other blocks.

The service level agreement may identify minimum performance characteristics or other parameters that may be used to configure and manage a logical unit. The service level agreement may include performance metrics, such as number of input/output operations per unit time, latency of operations, bandwidth or throughput of operations, and other performance metrics. In some cases, a service level agreement may include optimizing parameters, such as preferring devices having lower cost or lower power consumption than other devices.

The service level agreement may include replication criteria, which may define a minimum number of different devices to store a given block. The replication criteria may identify certain types of storage devices to include or exclude.

The storage management system may receive a desired size of a logical unit along with a desired service level agreement. The storage management system may identify a group of available devices that may meet the service level agreement and provision the logical unit using the available devices.

During operation of the logical unit, the storage management system may identify when the service level agreement may be exceeded or may be near a threshold. The storage management system may reconfigure the provisioned devices in many different manners, for example by converting from synchronous to asynchronous write operations or striping read operations. In some cases, the storage management system may add or remove devices from supporting the logical unit, as well as moving blocks from one device to another to increase performance or otherwise meet the storage level agreement.

Throughout this specification, like reference numbers signify the same elements throughout the description of the figures.

When elements are referred to as being “connected” or “coupled,” the elements can be directly connected or coupled together or one or more intervening elements may also be present. In contrast, when elements are referred to as being “directly connected” or “directly coupled,” there are no intervening elements present.

The subject matter may be embodied as devices, systems, methods, and/or computer program products. Accordingly, some or all of the subject matter may be embodied in hardware and/or in software (including firmware, resident software, micro-code, state machines, gate arrays, etc.) Furthermore, the subject matter may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. By way of example, and not limitation, computer readable media may comprise computer storage media and communication media.

Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can accessed by an instruction execution system. Note that the computer-usable or computer-readable medium could be paper or another suitable medium upon which the program is printed, as the program can be electronically captured, via, for instance, optical scanning of the paper or other medium, then compiled, interpreted, of otherwise processed in a suitable manner, if necessary, and then stored in a computer memory.

When the subject matter is embodied in the general context of computer-executable instructions, the embodiment may comprise program modules, executed by one or more systems, computers, or other devices. Generally, program modules include routines, programs, objects, components, data structures, etc. that perform particular tasks or implement particular abstract data types. Typically, the functionality of the program modules may be combined or distributed as desired in various embodiments.

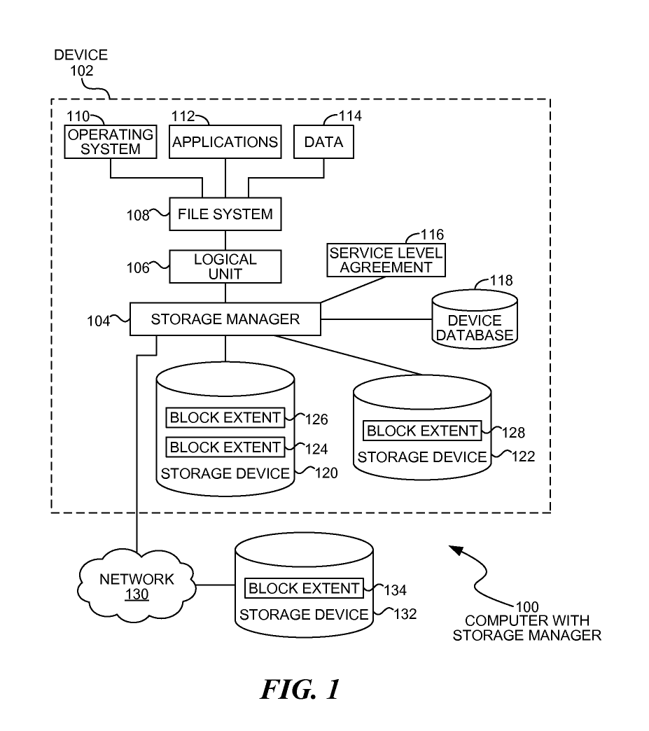

FIG. 1 is a diagram of an embodiment 100 showing a computer system 102 with a storage management system. Embodiment 100 illustrates a storage management system 104 that creates a logical unit 106 that a file system 108 may use to store and retrieve data.

The storage management system 104 may use multiple storage devices to create and manage the logical unit 106. The logical unit 106 may operate as a single storage device to the file system 108, and the file system 108 may interact with the logical unit 106 as if the logical unit 106 was a single disk drive or other storage mechanism.

The storage management system 104 may manage the logical unit 106 by placing blocks of data on various storage devices. The blocks of data may be presented to the file system 108 as a single storage device. In many embodiments, the file system 108 may not be aware that the logical unit 106 may not be composed of multiple storage devices.

The storage management system 104 may duplicate data on different storage devices. Duplicate storage of data may provide redundancy in the case of failure of one or more devices in the system. In many cases, one of the duplicate copies of data may be on a remote device that may be accessed over a network or other connection. When at least one copy is located on a remote device, the failure of the local device may not limit access to the data.

For example, a server computer may contain a virtual hard disk from which a virtual machine may operate. A copy of the virtual hard disk may be stored on the local storage for the server computer, and a duplicate copy of the virtual hard disk may be stored on a remote device. When the copy of the virtual hard disk is up to date, a complete failure of the server computer may be overcome by restarting the virtual machine from the remote copy of the virtual hard disk.

During normal operations, the remote copy of the virtual hard disk in our example may be maintained using synchronous write operations. In such operations, each write operation may be completed only when all devices successfully complete the write operation. After each device has completed the operation, the storage management system 104 may consider the write operation successful.

In many cases, a remote copy may be configured over a high speed network connection where a write operation may not cause a significant delay. In such cases, a synchronous write operation may be performed while maintaining a service level agreement. When the network connection becomes intermittent or fails, the synchronous write operations may cause the system to perform below the service level agreement. At such a point, the storage manager 104 may add a new device to the storage system and use the new device as a substitute for the remote device, then the storage manager 104 may configure the remote device to receive asynchronous write operations.

When the remote device is operating in an asynchronous write configuration, the storage manager 104 may create a differencing file on one or more local storage devices or use other mechanisms that may update the remote storage device. The storage manager 104 may monitor the connection and availability of the remote device to determine when and if the remote device may be capable of returning to synchronous write operations. If the remote device comes back on line or is otherwise capable of synchronous write operations, the storage manager 104 may switch back to synchronous write operations.

In such embodiments, the storage manager 104 may apply a service level agreement 116 to individual files or groups of files. For example, a specific file or file directory may be designated to meet specific storage and retrieval performance standards. The storage manager 104 may determine that a service level agreement is not being met and may move the file or group of files to a different block extent with a different block size to meet the performance metric for the service level agreement. In some cases, the storage manager 104 may change from synchronous to asynchronous write operations for that file type when the service level agreement is not being met.

In another example, a file or group of files may be designated to be a certain file type. The service level agreement 116 may determine that files of a certain type are to be stored with at least two local copies and one remote copy of the file. In such a case, the storage manager 104 may configure storage for a logical unit such that two local copies and one remote copy are maintained.

The service level agreement 116 may define a set of performance metrics for a logical unit. In some cases, the service level agreement 116 may define alternative configurations when one or more performance metrics are not being met. For example, when a remote device is not able to meet the service level agreement 116 for synchronized write operations, the logical unit may be reconfigured so that the remote device operates with asynchronous write operations while two or more other local devices operate with synchronous write operations.

The file system 108 may manage files of data which may be accessed by an operating system 110 and various applications 112. The file system 108 may also store data 114 that may be accessed by the operating system 110 and applications 112.

A service level agreement 116 may define the performance metrics and other characteristics of the logical unit 106. The storage management system 104 may create the logical unit 106 according to the service level agreement 116, and then manage the logical unit 106 to meet the service level agreement 116 during operation.

Prior to creating the logical unit 106, the storage management system 104 may take an inventory of available storage devices and store descriptors of the storage devices in a device database 118. The inventory may include static descriptors of the various devices, including network address, physical location, available storage capacity, model number, interface type, and other descriptors.

The inventory may also include dynamic descriptors that define maximum and measured performance. The storage management system 104 may perform tests against a storage device to measure read and write performance, which may include latency, burst and saturated throughput, and other metrics. In some embodiments, the storage management system 104 may measure dynamic descriptors over time to determine when a service level agreement may not be met or to identify a change in a network or device configuration. In some embodiments, the storage devices may measure and capture various performance parameters. The storage management system 104 may manage many different types of devices to create and manage the logical unit 106. In the example of embodiment 100, storage devices 120 and 122 are illustrated as locally accessible devices. Storage device 120 may have two block extents 124 and 126, each of which may have different block sizes. Storage device 122 may have a block extent 128.

The storage manager 104 may also access various network connected storage devices. The illustration of embodiment 100 shows a network 130 where storage device 132 may be accessed with a block extent 134.

The storage manager 104 may configure all of the various block extents to create the logical unit 106 presented to the file system 108. The block extents may be configured to be duplicates of each other for redundancy, performance, or other reasons. Once the block extents are configured as a logical unit 106, the storage manager 104 may reconfigure the block extents as changes occur.

For example, one device may become unavailable or have degraded performance. The storage manager 104 may identify a replacement device and bring the replacement device online as part of the logical unit 106, then deprecate or decommission the failing device. While such changes are being made, the logical unit 106 may continue operations.

Each of the various types of devices may have different performance or other characteristics. For example, locally attached devices may have faster response times than network attached devices. Some devices may have a higher capital cost or a higher operating cost. In many cases, higher performance devices may come with an increased capital cost or energy consumption.

Some devices may different reliability characteristics. Spinning media, notably hard disk drives, may fail in a catastrophic fashion, while solid state storage media may tend to fail gradually.

In each case, the storage devices may store various blocks of data, as opposed to storing individual files. In some instances, a single file may have part of the file stored in a first group of blocks on a first device, while another part of the file may be stored in a second group of blocks on a second device.

The block level management of a logical unit may enable the storage management system 104 to treat each block of data separately. For example, some blocks of a logical unit 106 may be accessed frequently while other blocks may not. The frequently accessed blocks may be placed on a storage device that offers increased performance, such as a local flash memory device, while other blocks may be placed on a device that offers poorer performance but may be operated at a lower cost.

The storage management system 104 may create and manage a logical unit 106 to meet criteria defined in a service level agreement 116. The service level agreement 116 may define a size for the logical unit 106, number of replications of blocks of data, and various performance characteristics of the logical unit 106.

The size of a logical unit 106 may be defined using thin or thick provisioning. In a thick provisioned logical unit, all of the storage requested for the logical unit may be provisioned and assigned to the logical unit. In a thin provisioned logical unit, the maximum size of the logical unit may be defined, but the physical storage may not be assigned to the logical unit until requested.

In a thin provisioned logical unit, the storage management system 104 may assign additional blocks of storage to the logical unit 106 over time. When the amount of storage actually being used grows to be close to the physical storage assigned, the storage management system 104 may identify additional storage for the logical unit. The additional storage may be selected to comply with the storage level agreement 116.

The number of replications of blocks of data may define how many different devices may store each block, as well as what type of devices. The replications may be used for fault tolerance as well as for performance characteristics.

Replications may be defined for fault tolerance by selecting a number of devices that store a block so that if one of the devices were to fail, the block may be retrieved from one of the remaining devices. In some embodiments, a replication policy may define that a local copy and a remote copy may be kept for each block. Such a policy may ensure that if the local device were compromised or failed, that the data may be recreated from the remote storage devices. In some policies, such remote devices may be defined to be another device within the same or different rack in a datacenter, for example. In some cases, a replication policy may define that an off premises storage device be included in the replication.

The replications may define whether a write operation may be performed in a synchronous or asynchronous manner. In an asynchronous write operation, the write operation may complete on one device, then the storage management system 104 may propagate the write operations to another device. When an off premises or other remote storage is used, some replication policies may permit the remote storage to be updated asynchronously, while writing synchronously to multiple local devices.

Replications may be defined for performance by selecting multiple devices that may support striping. Striping read operations may involve reading from multiple devices simultaneously, where each read operation may read a different block or different areas of a single block. As all of the data are read, the various portions of data may be concatenated and transmitted to the file system 108. Striping may increase read performance by a factor of the number of devices allocated to the striping operation.

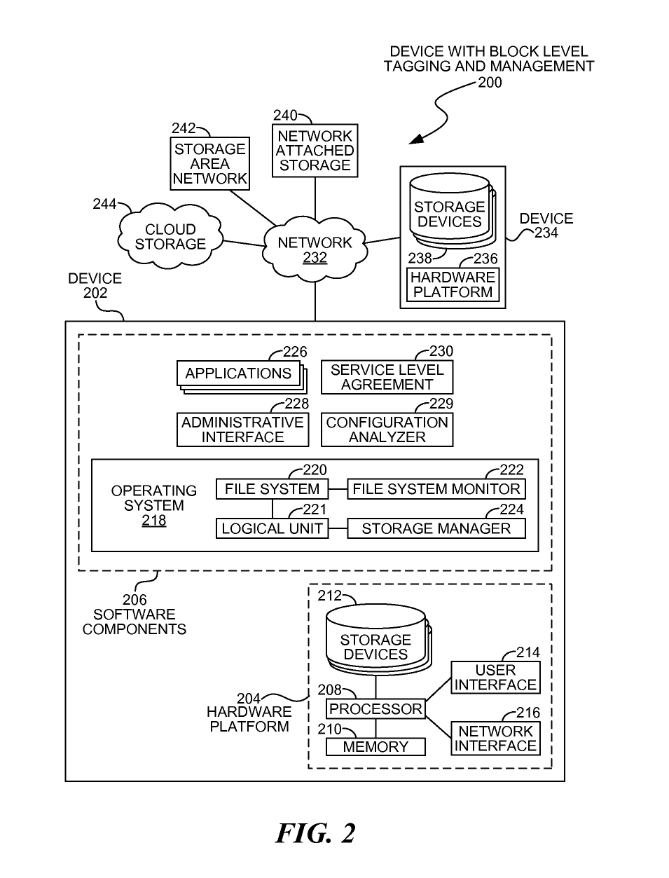

FIG. 2 is a diagram of an embodiment 200 showing a computer system with a storage management system that may store files using storage from multiple devices. The storage management system may create and manage a logical unit for storage accessible by an operating system and applications, where the storage blocks may be managed independently of files or other storage constructs. Policies may be implemented on a file system level but the management of storage media may occur at a block level.

The diagram of FIG. 2 illustrates functional components of a system. In some cases, the component may be a hardware component, a software component, or a combination of hardware and software. Some of the components may be application level software, while other components may be execution environment level components. In some cases, the connection of one component to another may be a close connection where two or more components are operating on a single hardware platform. In other cases, the connections may be made over network connections spanning long distances. Each embodiment may use different hardware, software, and interconnection architectures to achieve the functions described.

Embodiment 200 may illustrate an example of a device that may have a managed logical unit that may operate with storage blocks. An operating system's file system may recognize the logical unit as a storage unit in the same way as a conventional disk drive may be treated as a storage unit.

The file system may address a logical unit using a constant block size, however, a storage management system may store the files using file extents with different block sizes. The storage management system may place files in different block extents based on a service level agreement as applied to the files. The different block sizes may affect access times, storage efficiency, and other factors that may or may not be defined in a service level agreement.

A file system monitor may identify and tag storage blocks with characteristics of the files to which the blocks belong. Once the blocks are tagged, the storage system may apply different policies defined in a service level agreement to those blocks.

The storage management system may use a service level agreement to define how each storage block may be managed. The service level agreement may define various redundancy criteria, performance metrics, or other parameters for the logical unit. The storage management system may attempt to meet the service level agreement in the initial configuration of a logical unit, as well as make changes to the storage system to meet the service level agreement during operations.

Block size for storing files may be one factor that a storage management system may use to meet a service level agreement. Larger files and files that are accessed sequentially may see a performance benefit when stored in larger block sizes, while smaller files and files that are accessed randomly may benefit from smaller block sizes.

Embodiment 200 illustrates a device 202 that may have a hardware platform 204 and various software components 206. The device 202 as illustrated represents a conventional computing device, although other embodiments may have different configurations, architectures, or components.

In many embodiments, the device 202 may be a server computer. In some embodiments, the device 202 may still also be a desktop computer, laptop computer, netbook computer, tablet or slate computer, wireless handset, cellular telephone, game console or any other type of computing device.

The hardware platform 204 may include a processor 208, random access memory 210, and nonvolatile storage 212. The hardware platform 204 may also include a user interface 214 and network interface 216.

The random access memory 210 may be storage that contains data objects and executable code that can be quickly accessed by the processors 208. In many embodiments, the random access memory 210 may have a high-speed bus connecting the memory 210 to the processors 208.

The nonvolatile storage 212 may be storage that persists after the device 202 is shut down. The nonvolatile storage 212 may be any type of storage device, including hard disk, solid state memory devices, magnetic tape, optical storage, or other type of storage. The nonvolatile storage 212 may be read only or read/write capable.

The user interface 214 may be any type of hardware capable of displaying output and receiving input from a user. In many cases, the output display may be a graphical display monitor, although output devices may include lights and other visual output, audio output, kinetic actuator output, as well as other output devices. Conventional input devices may include keyboards and pointing devices such as a mouse, stylus, trackball, or other pointing device. Other input devices may include various sensors, including biometric input devices, audio and video input devices, and other sensors.

The network interface 216 may be any type of connection to another computer. In many embodiments, the network interface 216 may be a wired Ethernet connection. Other embodiments may include wired or wireless connections over various communication protocols.

The software components 206 may include an operating system 218 that may have a file system 220 that interacts with a logical unit 221 provided by a storage management system 224. A file system monitor 222 may detect, classify, and tag each storage block managed by the storage manager 224. The operating system 218 may provide an abstraction layer between the hardware platform 204 and various software components, which may include applications, services, and various kernel and user level software components.

The file system 220 may create and manage files that may be accessed by the operating system 218 as well as various applications 226. The file system 220 may create files, apply permissions and various access controls to the files, and manage the files as distinct groups of storage.

The logical unit 221 may store the files in blocks of storage that may be allocated to the files. As files grow, additional blocks within the logical unit 221 may be assigned to the files.

The storage management system 222 may create and manage the storage according to a service level agreement 230.

A file system monitor 222 may detect all file system changes and may tag each block of data that may be created or changed with information that may enable the storage manager 224 to apply the service level agreement 230.

An administrative user interface 228 may have a user interface through which a system administrator may configure and manage the storage management system. The user interface may allow the administrator to define a logical unit 221 and set the parameters by which the logical unit 221 may be operated, which may include defining and editing a service level agreement 230. In some cases, the user interface may also allow the user to view the current and historical performance of the logical unit 221.

A configuration analyzer 229 may populate and update a database of available storage devices. The configuration analyzer 229 may discover all available storage devices and determine static and dynamic capacities of those devices. A static capacity may include currently available storage, physical location, network or local address, device type, and other parameters. Dynamic capacities may include various performance metrics that may be tested, measured, and monitored during operation. Such metrics may be burst and sustained bandwidth, latency, and other parameters.

The configuration analyzer 229 may monitor the storage devices over time. In some cases, the performance, capacity, or other parameters may change, which may trigger the storage management system 224 to make changes to the logical unit 221 in order to meet the service level agreement 230.

In some embodiments, the various storage management system components may communicate over a network 232 to access and manage various remote storage systems. A remote storage system may be a device 234 that has a hardware platform 236 on which various storage devices 238 may be made available. In some cases, the storage devices 238 may be iSCSI based storage target or other devices that may be accessed over a network 232. The remote storage systems may include network attached storage 240, storage area networks 242, cloud storage 244, and other storage devices that may be accessed over the network 232. In some cases, a service level agreement 230 may define that some or all of the blocks of data in the logical unit be stored on remote storage devices.

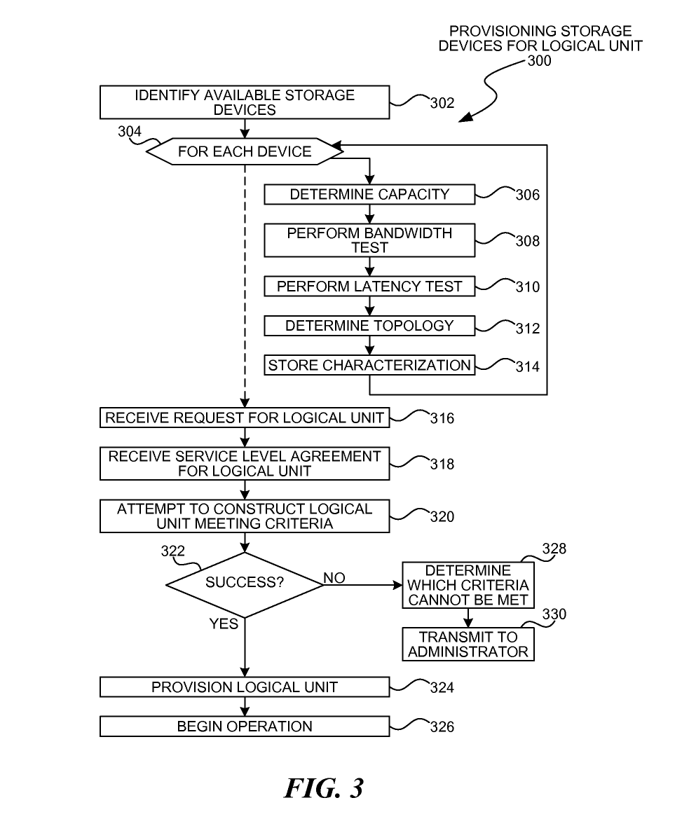

FIG. 3 is a flowchart illustration of an embodiment 300 showing a method for provisioning storage devices for a logical unit. Embodiment 300 illustrates one method by which a service level agreement may be used to configure and deploy a logical unit after gathering metadata about the available storage devices.

Other embodiments may use different sequencing, additional or fewer steps, and different nomenclature or terminology to accomplish similar functions. In some embodiments, various operations or set of operations may be performed in parallel with other operations, either in a synchronous or asynchronous manner. The steps selected here were chosen to illustrate some principles of operations in a simplified form.

In block 302, all of the available storage devices may be identified. In some embodiments, a crawler or other automated component may detect and identify local and remotely attached storage devices. In some embodiments, a user may identify various storage devices to the system. Such embodiments may be useful when remotely available storage devices may not be readily accessible or identifiable to a crawler mechanism.

For each device in block 304, the capacity may be determined in block 306. The capacity may include the amount of raw storage that may be available on the device.

A bandwidth test may be performed in block 308 to determine the burst and sustained rate of data transfer to and from the device. Similarly, a latency test may be performed in block 310 to determine any initial or sustained latency in communication with the storage device. In some embodiments, the bandwidth and latency tests may be a dynamic performance test, where the communication to the device may be exercised. In some embodiments, the bandwidth and latency may be determined by determining the type of interface to the device and deriving expected performance parameters.

A dynamic performance test may be useful when a storage device may be accessed through a network or other connection. In such cases, the network connections may add performance barriers that may not be determinable through a static analysis of the connections.

The topology of the device may be determined in block 312. The topology may define the connections from a logic unit to the storage device. The topology may include whether or not the device may be local to the intended computing device. For remotely located devices, the topology may include whether the device is in the same or different rack, the same or different local area network, the same or different datacenter or other geographic location.

In many embodiments, a service level agreement may enforce a duplication parameter where duplicates of each block may be stored in various remote locations. For example, a service level agreement may define that a copy of all blocks be stored in a datacenter within a specific country but remote from the device accessing the logical unit.

The topology may also define the block sizes possible for each device. In some devices, the block size may be determined when the device is initially formatted and may not be changed thereafter. Other devices may have unformatted portions of storage that a storage manager may subsequently format using a specific block size.

After determining the topology and other metadata about the storage devices, the characterization of the storage devices may be stored in block 314.

A request for a logical unit may be received in block 316. The service level agreement may be received in block 318 for the logical unit.

In block 320, an attempt to construct a logical unit may be made according to the service level agreement. The logical unit may be constructed by first identifying storage devices that may meet the performance metrics defined in a service level agreement. In some cases, the performance metrics may be met by combining two or more storage devices together, such as striping devices to increase read performance.

The service level agreement may define that several replications of specific block extents, files, or complete logical units be implemented. In many such cases, one of the replications may be a remote device. The service level agreement may define that write operations be performed synchronously across the group of storage devices. The storage manager may monitor the write operations and may reconfigure the devices supporting a logical unit when the performance of the logical unit falls below a predefined standard. In such cases, the storage manager may change from synchronous write operations to asynchronous write operations on a temporary basis and revert to synchronous write operations when able.

Once the performance metrics may be met, the storage capacity of a logical unit may be attempted to be met by provisioning the storage devices. In some cases, the provisioning may be thin provisioning, where the full physical storage capacity may not be assigned or provisioned, and where the full physical storage capacity may or may not be available at the time the storage is provisioned.

The provisioning exercise in block 320 may include provisioning specific storage devices with specific block sizes for storage.

If the storage management system has determined that a logical unit may be provisioned with success in block 322, the logical unit may be provisioned in block 324 and may begin operation in block 326.

If the storage management system determines that the service level agreement may not be met in block 322 to result in a successful provisioning, the criteria that may not be met may be determined in block 328. These criteria may be presented to an administrator in block 330, and the administrator may elect to change the criteria or make other changes to the system to meet the criteria. In some cases, the administrator may add more storage devices to the available storage devices to meet the deficiencies identified in block 328.

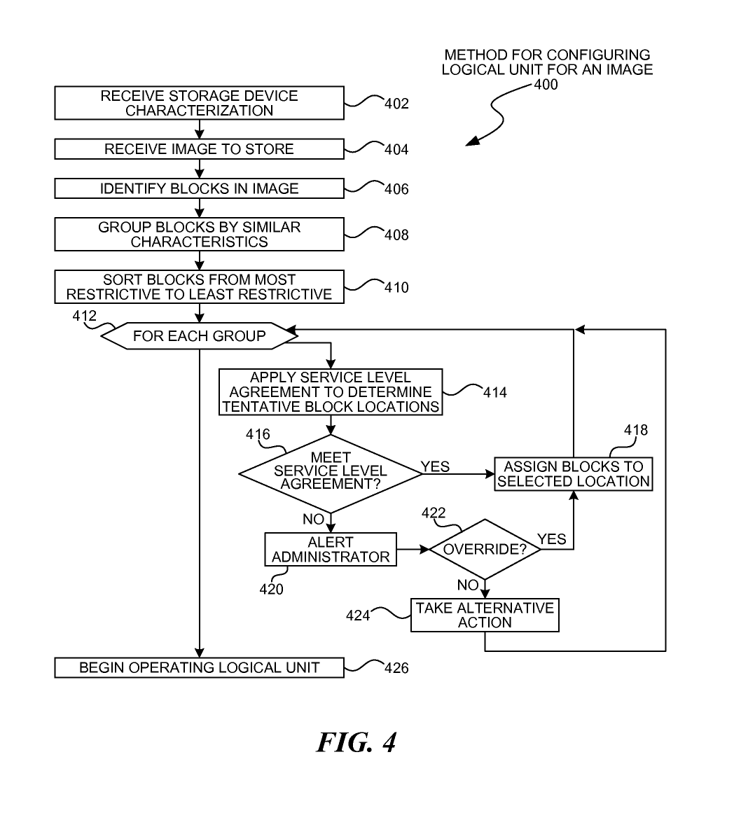

FIG. 4 is a flowchart illustration of an embodiment 400 showing a method for configuring a logical unit for a given image. Embodiment 400 illustrates one method by which blocks in an image may be examined and placed on a set of available storage devices to best meet a service level agreement.

Other embodiments may use different sequencing, additional or fewer steps, and different nomenclature or terminology to accomplish similar functions. In some embodiments, various operations or set of operations may be performed in parallel with other operations, either in a synchronous or asynchronous manner. The steps selected here were chosen to illustrate some principles of operations in a simplified form.

The characterizations of available storage devices may be received in block 402. The characterizations may define the capabilities, performance, and other parameters about the available storage devices.

An image may be received in block 404. An image may include all of the blocks for a logical unit, which may be identified in block 406. The image may contain blocks with different tags that define how the block may be classified and used.

The blocks may be grouped in block 408 by similar characteristics, and sorted in block 410 from the most restrictive to the least restrictive. Each group of blocks may be processed in block 412.

For each group of blocks in block 412, a service level agreement may be applied to identify tentative locations for the block. The service level agreement may define the desired block size for storage, along with performance, number of copies of blocks, and other parameters. In many cases, the service level agreement may define one set of parameters for one type of block and another set of parameters for another type of block. As such, each group of blocks may be treated differently by the service level agreement.

If the tentative placement of the blocks meets the service level agreement in block 416, the blocks may be assigned to the selected location in block 418. If the service level agreement is not met in block 416, an administrator may be alerted in block 420. The administrator may elect to override the service level agreement in block 422, in which case the blocks may be placed according to the selected location in block 418. Otherwise, the administrator may take alternative action in block 424, which may be to add more storage devices, change the placement of the logical unit, or other action.

Once each group is placed on the storage devices, the logical unit may begin operation in block 426.

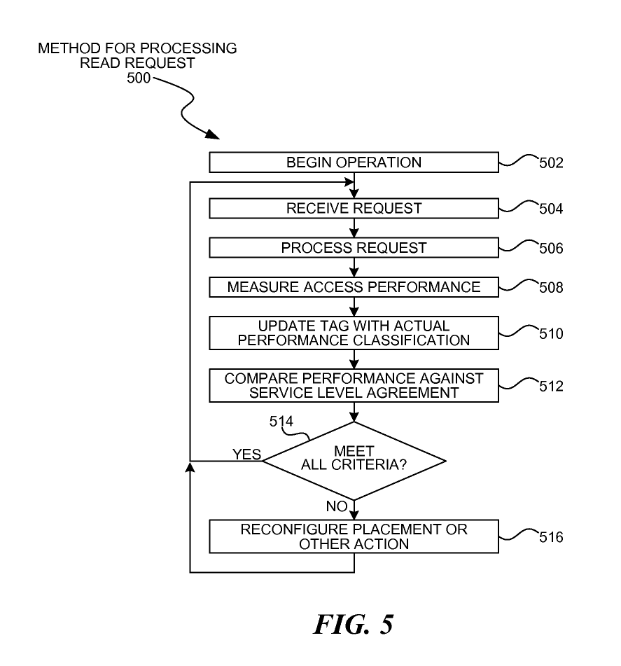

FIG. 5 is a flowchart illustration of an embodiment 500 showing a method for operating a logical unit and specifically processing a read request. Embodiment 500 illustrates how the service level agreement may be used to identify storage blocks that may be reconfigured to meet a service level agreement.

Other embodiments may use different sequencing, additional or fewer steps, and different nomenclature or terminology to accomplish similar functions. In some embodiments, various operations or set of operations may be performed in parallel with other operations, either in a synchronous or asynchronous manner. The steps selected here were chosen to illustrate some principles of operations in a simplified form.

A logical unit may begin operation in block 502. As part of normal operation, the logical unit may receive a request, which may be a read request, in block 504. The request may be processed in block 506.

During the operation, a storage manager may measure access performance of the system in block 508. The tags for any blocks processed by the system may be updated in block 510 with an actual or measured performance classification.

The actual or measured performance may be compared against the service level agreement in block 512. If the service level agreement is met in block 514, the process may return to block 504 to process additional requests. If the service level agreement is not met in block 514, the blocks may be reconfigured in block 516 or other action may be taken.

The reconfiguration in block 516 may move blocks from one storage device to another device that may have increased or decreased performance. In some instances, the reconfiguration may be to move blocks from one block extent to another block extent. When the block extents have different block sizes, the system may convert from one block size to another for storage.

For example, a block that may be accessed infrequently may be moved to a slower performing storage device, while a block that may be accessed very frequently may be moved to a higher performing storage device.

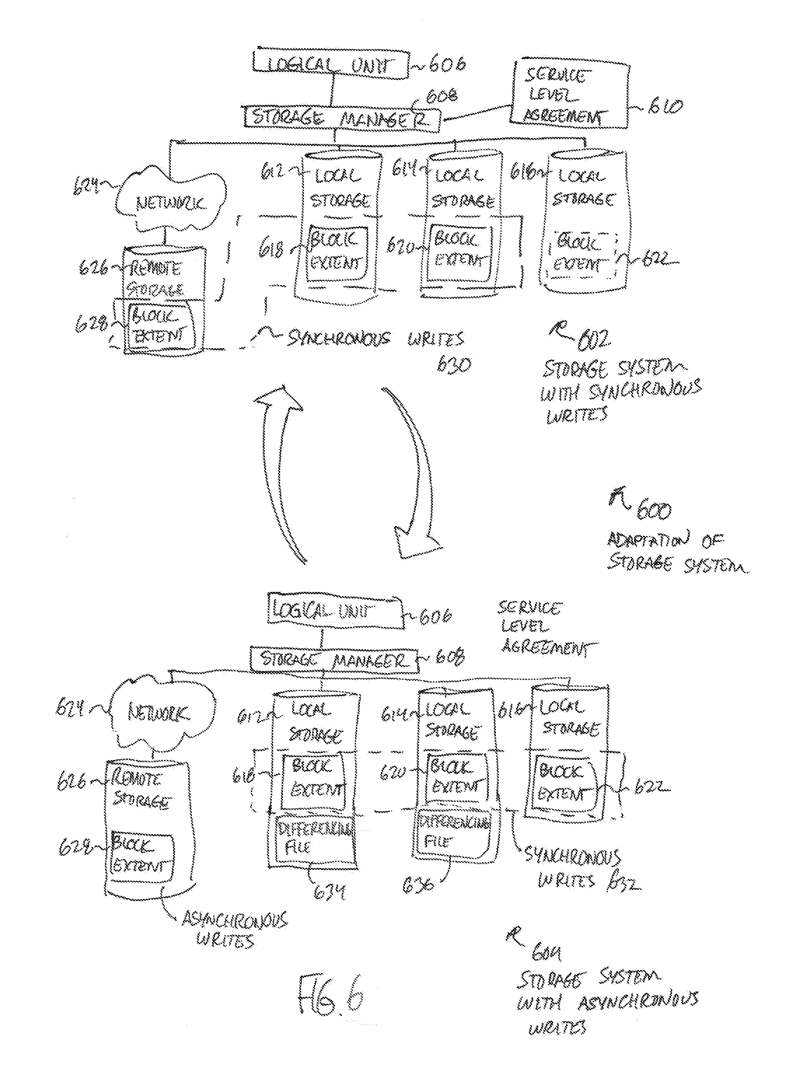

FIG. 6 is a diagram illustration of an embodiment 600 showing a two states of a storage system that may reflect how a storage system may adapt to changes in the availability of a storage device.

Embodiment 600 shows state 602 where a storage system accesses a remote device using synchronous writes. In state 604, the same storage system may be reconfigured to add another local device to synchronous writes, but change the remote device to asynchronous writes. A storage manager may change from state 602 to 604 and back again as the availability of the remote device changes.

In the example of embodiment 600, the operations of a remote device are shown as causing the remote device to be added or removed from a synchronous write operation. In other cases, any of the storage devices may be added or removed from a synchronous write operation.

In state 602, a logical unit 606 may be managed by a storage manager 608 that provides storage resources in compliance with a service level agreement 610. The storage manager 608 may have local devices 612, 614, and 616, each having respective block extents 618, 620, and 622. The storage manager 608 may also have a remote device 626 with block extent 628 that may be available through a network 624.

The storage manager 608 may be configured to perform synchronous writes 630 across the block extents 618, 620, and 628. The synchronous writes 630 may be a preferred configuration defined in the service level agreement 610.

At some point during operations, the remote device 626 may become unavailable or access to the remote device 626 may cause the system to fall below a standard defined in the service level agreement 610. At such a point, the storage manager 608 may add the block extent 622 to the synchronous write 632 and change the remote device 626 to asynchronous write.

When the remote device 626 is operated in asynchronous write mode, a differencing file may be created on storage devices 612 and 614. The differencing file 634 and 636 may reflect a duplicate of the differencing file created for redundancy, performance, or other reasons.

The differencing file 634 and 636 may include the differences between the block extent 628 on the remote device 626 and the block extents 618 and 620 on the storage devices 612 and 614. The differencing file may be used to update the block extent 628 in an asynchronous manner, such as after a connection to the remote device 626 is restored for example.

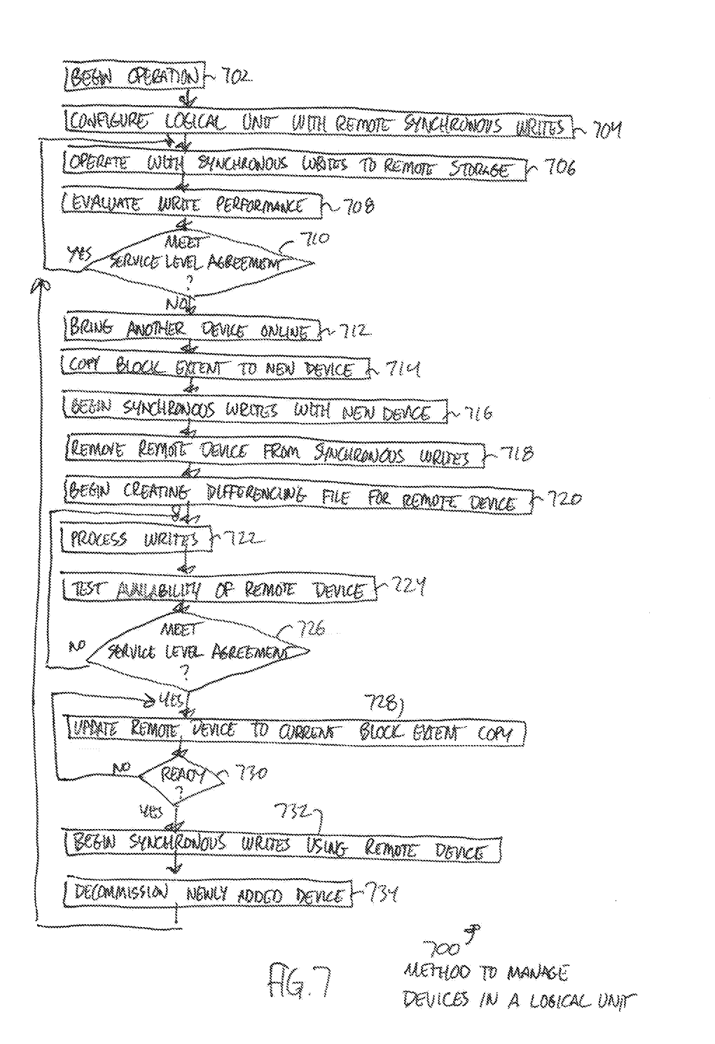

FIG. 7 is a flowchart illustration of an embodiment 700 showing a method for operating a logical unit and specifically changing the configuration of the storage devices from synchronous writes to asynchronous writes and back again. In the example of embodiment 700, a remote device is used as an example of a device that is changed from synchronous to asynchronous operation and back. In other cases, a local device or other storage device may be changed from synchronous to asynchronous write operations.

Other embodiments may use different sequencing, additional or fewer steps, and different nomenclature or terminology to accomplish similar functions. In some embodiments, various operations or set of operations may be performed in parallel with other operations, either in a synchronous or asynchronous manner. The steps selected here were chosen to illustrate some principles of operations in a simplified form.

The operation of a logical unit may begin in block 702. The logical unit may be configured in block 704 with synchronous writes to a remote device.

The logical unit may be operated in block 706 with synchronous writes to the remote storage device. During the operations, a storage manager may evaluate the write performance in block 708. When the performance meets a service level agreement in block 710, the process may return to block 706 and continue operation.

When the performance does not meet a service level agreement in block 710, the storage manager may change the configuration of the storage system to asynchronous write operations with the poorly performance device.

The changeover from synchronous to asynchronous write operations may begin by bringing another device online in block 712 and copying a block extent to the new device in block 714. Once the new device is ready to begin synchronous writes, the synchronous writes to the new device may begin in block 716.

The remote device may be removed from synchronous writes in block 718 and a differencing file may be created in block 720 and updated for future writes.

The normal operation of processing writes in block 722 may occur in block 722. On a periodic or other basis, the remote device may be tested in block 724 to determine if the remote device may be ready to resume synchronous writes. If the device is not able to meet the service level agreement in block 726, the process may return to block 722.

When the remote device is performing at a level such that the service level agreement may be met in block 726, the remote device may be updated to the current block extent in block 728. The updating may use the differencing file to update the old version of the block extent to a current version.

When the remove device has completed synchronizing with the remaining devices and is ready in block 730, synchronous write operations may resume to the remote device in block 732, and the device added to the system in block 712 may be decommissioned in block 734. The system may revert to block 706 for synchronous write operations.

The foregoing description of the subject matter has been presented for purposes of illustration and description. It is not intended to be exhaustive or to limit the subject matter to the precise form disclosed, and other modifications and variations may be possible in light of the above teachings. The embodiment was chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments except insofar as limited by the prior art.

What is claimed is:

1. A method performed on a computer processor, said method comprising:
configuring a plurality of storage devices to operate as a storage system, said plurality of storage devices comprising a remote storage device, said remote storage device being accessed over a first connection;
receiving a service level agreement defining a performance metric for write operations;
operating said storage system in compliance with said service level agreement and performing synchronous write operations across said plurality of storage devices;
determining that said service level agreement is not being met when performing said synchronous write operations and that said remote storage device is causing said service level agreement to not be met; and
changing said storage system configuration so that write operations are performed asynchronously with respect to said remote storage device.

2. The method of claim 1, when said write operations are performed asynchronously, simultaneously performing said write operations synchronously with at least two of said plurality of storage devices.

3. The method of claim 2 further comprising:
identifying a second storage device;
adding said second storage device to said storage system; and
performing synchronous write operations with said second storage device.

4. The method of claim 3, said second storage device being identified after determining that said service level agreement is not being met.

5. The method of claim 4, said second storage device being a local storage device.

6. The method of claim 4, said second storage device being a second remote storage device.

7. The method of claim 1 further comprising:
while said write operations are performed asynchronously, determining that said remote storage device is capable of meeting said service level agreement; and
returning to operating said remote storage device for synchronous write operations.

8. The method of claim 7 further comprising:
while said write operations are performed asynchronously, creating a differencing file comprising changes to said remote storage device; and
using said differencing file to update said remote storage device.

9. The method of claim 8, said update said remote storage device being performed while said write operation are performed asynchronously.

10. The method of claim 8, said update said remote storage device being performed after determining that said remote storage device is capable of meeting said service level agreement.

11. The method of claim 1, said remote storage device being accessed over a network connection.

12. A system comprising:
a plurality of storage devices, at least one of said plurality of storage devices being a remote storage device accessed over a first connection;
a storage system controller that:
configures said plurality of storage devices to operate as a storage system;
receives a service level agreement defining a performance metric for write operations;
operates said storage system in compliance with said service level agreement and performing synchronous write operations across said plurality of storage devices;
determines that said service level agreement is not being met when performing said synchronous write operations and that said remote storage device is causing said service level agreement to not be met; and
changes said storage system configuration so that write operations are performed asynchronously with respect to said remote storage device.

13. The system of claim 12, said storage system controller that further:
while said write operations are performed asynchronously, determines that said remote storage device is capable of meeting said service level agreement; and
returns to operating said remote storage device for synchronous write operations.

14. The system of claim 13 further comprising:
a storage device analyzer that tests said remote storage device to determine when said remote storage device is capable of meeting said service level agreement

15. The system of claim 14, said storage device analyzer that further:
tests each of said plurality of storage devices to determine performance characteristics for each of said plurality of storage devices.

16. The system of claim 15 further comprising:
a performance database comprising said performance characteristics for each of said plurality of storage devices.

17. The system of claim 16, said storage device analyzer that performs active tests on said remote storage device when said remote storage device is operated in an asynchronous write mode.
